(19) United States
(12) Patent Application Publication
(10) Pub. No.: US 2016/0047402 A1
(43) Pub. Date: Feb. 18, 2016

(54) MULTIPURPOSE QUICK RELEASE MOUNTING SYSTEM FOR PORTABLE EQUIPMENT AND ELECTRONIC DEVICES AND ITS METHODS OF USE

(71) Applicant: JUAN CARLOS MARTINEZ GONZALEZ, MAINZ (DE)

(72) Inventor: JUAN CARLOS MARTINEZ GONZALEZ, MAINZ (DE)

(21) Appl. No.: 14/461,437

(22) Filed: Aug. 17, 2014

(51) Int. Cl. F16B 2/06

(52) U.S. Cl. CPC F16B 2/065

(57) ABSTRACT

A multipurpose quick release mounting system for portable equipment and electronic devices and associated method of use is disclosed. The system includes a quick release device, a connector piece and clamping plates that can securely affix a portable equipment or electronic device by a frontal gesture to different surfaces and elements allowing its locking and release through a quick release actuator located in the quick release device.

### CROSS-REFERENCES TO RELATED APPLICATIONS

This is a continuation-in-part of application Ser. No. 61/867,119 filed Aug. 18, 2013.

### TECHNICAL FIELD

The present application relates to a multipurpose quick release mounting system and methods of use for quickly and safely mounting portable equipment and electronic devices. In particular, the present application relates to a quick release device and methods for attaching portable equipment and electronic devices to stands equipment, soft and hard equipment such straps, belts and other surfaces.

### BACKGROUND

Portable devices including but not limited to cameras, video cameras, navigation instruments, weather instruments, accessories for cameras, binoculars, etc. need to be immediately accessible as well as adequately secured during manipulation and transporting to avoid damages or loss of items.

Because of the wide availability of gadgets, users owns and use in combination more than one type of device in many different arrangements, also devices are carried in different ways, leaving a gap in the effort to connect them together in an efficient, multipurpose and easy way using only one mounting system with wide compatibility, easy access release function and secure fixing method. Existing products in the market does not cover all those necessities at once; some of them limitations are listed as follows.

Those offering “side or slide in” connection motion result in a difficult movement to perform while not looking directly at the connection slot.

Those using a “shoe” attachment piece are only compatible with one or two types of supporting systems like tripods, monopods, etc. or one or two product brands and those cannot use the same connecting piece for multiple supporting devices in an economical and simple way, compatibility is very limited.

Those using a “shoe” as connector piece can only position the attached device, such as cameras, in four different directions, as the so called “shoe” and its housing plate called “chassis” has a square geometry with only four corresponding sides.

Those using a plate called “chassis” are fixed by means of screws affixed to the “chassis” which limits its mobility to perform different purpose or those are not easy to insert through tight or reduce connecting points, slots or straps, also the risk of bending the fixing screws while trying to insert the “chassis” into a tight gap is high.

Those using a plate called “chassis”, comprises a release actuator integrated to the “chassis” which is not easy to operate with one hand while simultaneously holding the device to be attached. This quick release system does not work without the said chassis as it comprises the release actuator. Also the release actuator change position in relation to the camera when the “chassis” is fixed in different way.

Some quick release devices using round base connectors allows free rotation of the portable device due to, for example, the circumferential geometry of the connector piece, lack of tightness, wear off of the implicated contact parts or not enough retention force of the system.

Other release actuators called “quick release devices” are operated with two fingers therefore a second hand is needed to hold the device.

Therefore a system that offers a wide range of compatibility, multipurpose functionality, immediately and easy access to the release actuator is required, for these and other reasons, improvements are desirable.

### SUMMARY

In accordance with the following disclosure, the above and other issues are addressed by the following:

In first place a quick release mounting system is disclosed. The quick release mounting system comprises a quick release device having a fastener element such as screw that directly attaches to portable devices or electronic equipment. The quick release device also includes anchor loops to be used for tethering. The quick release device also comprises a quick release actuator that liberates the connector piece when actioned, this separates the quick release device from the connector piece by the operator. Additionally comprises a safety lock that fix the connector securely and firmly to the quick release device as a redundant safety element. The device also comprises a connector piece having a polygonal and conical configuration in such way that it could be easily inserted in the quick release device in different directions, once it is fixed and secure, it does not freely rotates or detaches from the quick release device by itself.

The device also comprises multipurpose supporting or clamping plates having rear and front plates with holes, slots, hollows, humps and cavities with the purpose of attaching or fixing the said supporting plates to different surfaces or elements by means of different kind of fasteners. The plates also comprises swivel or fixed fasteners, for example, a screw—lug nut arrangement. The screw, in this mentioned case, is attached to one of the plates by fastener elements, such as pins, pintles or bolts, in a manner that the swivel tensioner element is free to rotate or swing, the second plate receives the tensioner and fixes the lug nut. Additionally. the mentioned plates comprises friction bits on the surface in contact with the fixing element.

In a second aspect, a method of attaching the quick release device to the connector piece is disclosed. The method includes affixing the connector piece to any suitable surface or element by means of fasteners associated with the connector piece. The method also includes affixing the quick release device to the portable equipment or electronic device using fasteners associated with the device. The connector piece is inserted into the connector piece location in the quick release device to affix, for example a camera, to the quick release device, the connector piece and the surface or element where the connector piece is mounted.

In a further aspect, a method of attaching the connector piece to the multipurpose supporting or clamping plates is disclosed. The method includes affixing the connector piece to one of the said plates using fasteners associated with the connector piece. The method also includes affixing the said clamping plates to any suitable surface or element by means of fasteners associated with the said clamping plates. The method also includes affixing the said clamping plates to any suitable element compressing the chosen element between the clamping plates by tighten the fasteners associated with the said clamping plates.

### BRIEF DESCRIPTION OF THE DRAWINGS

FIG. 1 is an upper right isometric view of the multipurpose quick release mounting system in conjunction with a portable device.

FIG. 2 is an upper right isometric view of the quick release device.

FIG. 3 is a bottom isometric view of the quick release device.

FIG. 4 is a lower isometric view of the connector piece.

FIG. 5 is an upper right isometric view of the front multipurpose supporting plate.

FIG. 6 is a lower isometric view of the front multipurpose supporting plate.

FIG. 7 is an upper right isometric view of the rear multipurpose supporting plate.

FIG. 8 is an upper right isometric view corresponding to the method of attaching the quick release device to the connector piece.

FIG. 9 is an upper right isometric view corresponding to the method of attaching the connector piece to the multipurpose supporting or clamping plates.

### DETAILED DESCRIPTION

Various embodiments of the present invention will be described in detail with reference to the drawings, wherein numerals are presented as reference of parts, components and assemblies. The presented reference to various embodiments does not limit the scope of the invention, which comprises the scope of the claims listed hereto. Additionally, any examples set forth in this specification are not intended to be limiting and merely set forth some of the many possible embodiments for the claimed invention.

In general terms, the present disclosure relates to a multipurpose quick release mounting system for portable equipment and electronic devices and its methods of use. Various embodiments of the multipurpose quick release mounting system can include a number of components including a quick release device affix to portable devices, such as camera, navigation instruments, etc., the quick release device receives and secures a connector piece, which can be affix to a support or stand base devices, such as tripods, monopods, dollies, etc. It also includes a multipurpose supporting or clamping plates that in conjunction or separated could be used to attached the portable device, quick release device and connector piece to different elements and bodies, such as straps, belts, belt loops, person's body, personal protection equipment.

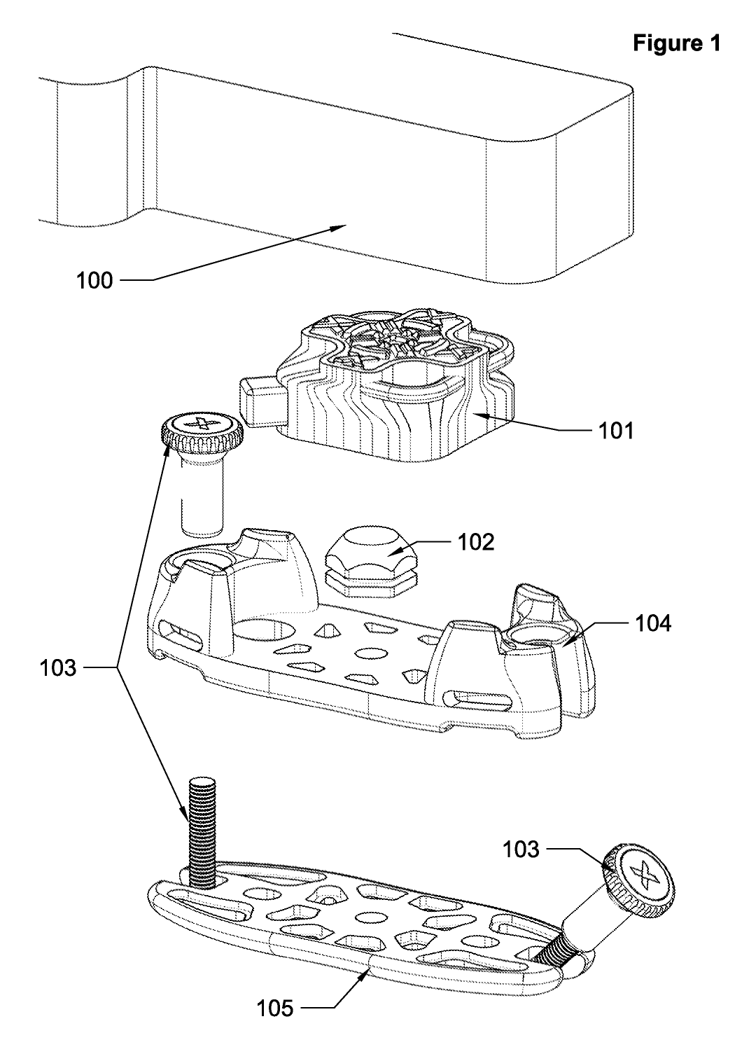

FIG. 1 is an upper right isometric view of the multipurpose quick release mounting system in conjunction with a portable device 100. The multipurpose quick release mounting system includes a quick release device 101, a connector piece 102, a multipurpose supporting or clamping front plate 104, a multipurpose supporting or clamping rear plate 105 and fastener elements 103.

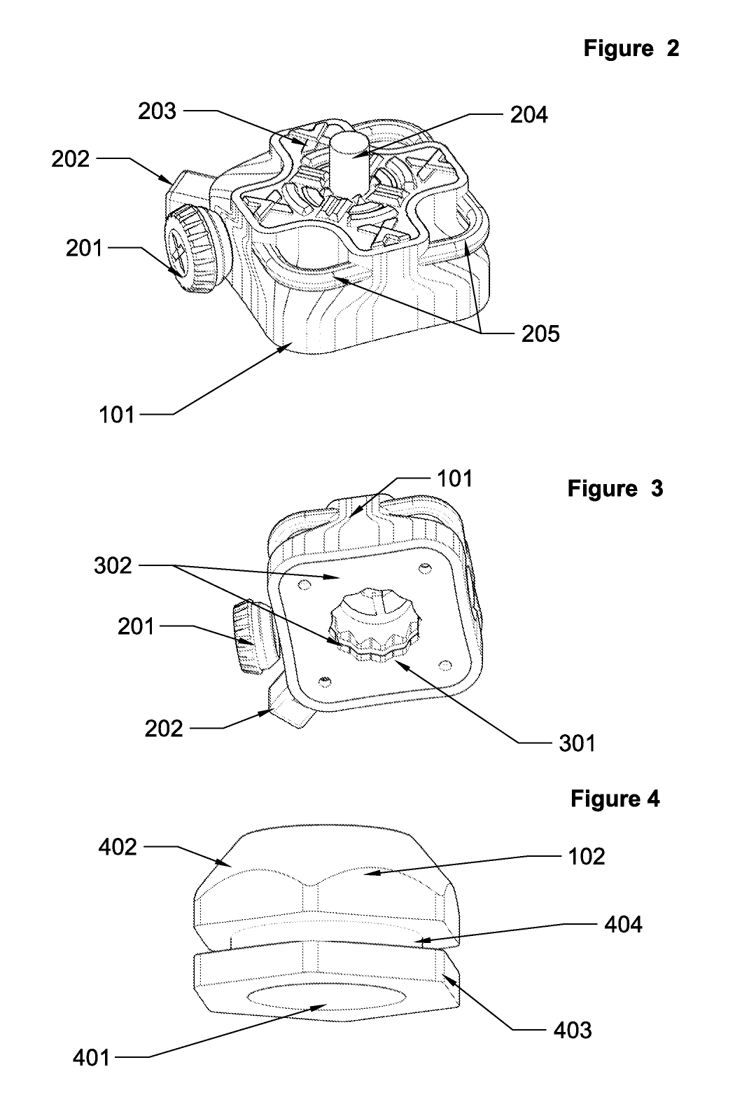

FIG. 2 is an upper right isometric view of the quick release device 101. The quick release mounting device comprises a fastener element 204 which allows the quick release device 101 to be attached to portable devices 101, a cushion and friction pad 203 to protect the portable devices 100 and avoid rotation when mounted. It also comprises anchor loops 205 tethering, for example, straps, cords, leashes, wires, etc. A quick release actuator 202 which easily secures or release the connector piece 102. It also comprises a safety lock 201 that fixes securely and firmly the connector piece 102 to the quick release device 101 as a redundant safety element.

In further aspects the quick release device 101 shown in FIG. 3 comprises a housing hollow 301 to receive the connector piece 102 when connected. It also comprises a cover plate at the bottom of the mounting device with a polygonal configuration 302 such as the connector piece 102 cannot freely rotate once it is on its place.

FIG. 4 shows the connector piece 102 from a lower isometric view. The connector piece 102 can be fixed by fasteners, such as screw, tighten in the hollow 401 in order to affix the connector piece 102 to diverse devices, for example, tripods, monopods, dollies, etc. The connector piece 102 have a polygonal and conical shape 402 that easily allows it to be inserted in the quick release device housing 301. It also comprises a groove 404 that allows the insertion of the quick release actuator 202 which secures or detaches the said connector piece with the action of the operator. Furthermore comprises a polygonal shape 403 that allows the quick release device 101 be inserted in many different direction and once it is fixed and secure by the quick release actuator 202, it restrings its free rotation.

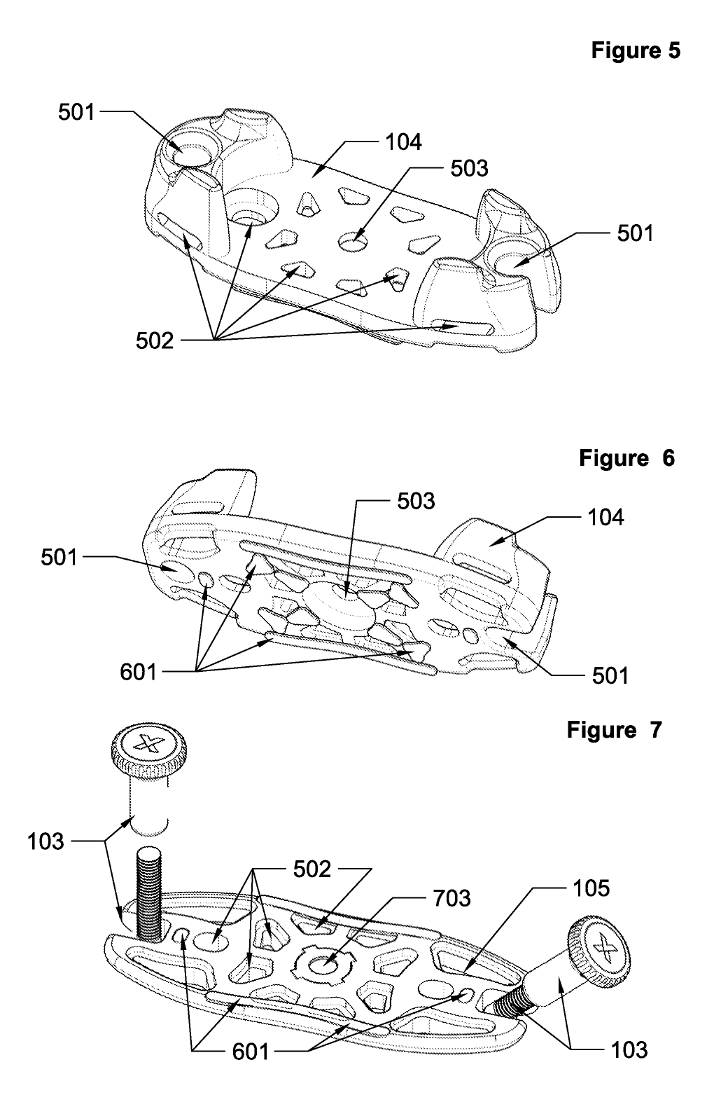

FIG. 5 shows an upper right isometric view of the front multipurpose supporting or clamping plate 104. The supporting plate 104 comprises a plate with hollows, holes, humps and cavities 502 with the purpose of attaching and fixing the front supporting plate 104 to any suitable surface or element by means of fasteners, such as, screws or other elements such as straps, bands, cords, webbings, wire, ropes, etc. It also comprises a hollow 503 to fix the connector piece 102 by means of the associated fastener to the front supporting plate 104. Furthermore comprises hollows 501 to be attached to the rear multipurpose or clamping plate 105 by means of fasteners 103.

FIG. 6 shows an isometric bottom view of the front multipurpose supporting or clamping plate 104 and friction bits 601 on the contact surface.

Illustrated in FIG. 7 is the rear multipurpose supporting or clamping plate 105 comprising a plate with hollows, holes, humps and cavities 502 with the purpose of attaching and fixing the rear plate 105 to, for example, person's body, cylindrical or rectangular object among others by means of fasteners, such as, screws, straps, bands, cords, webbings, wire, ropes, etc. The said plate also comprises a hollow 703 to receive a fastener, such as screw to affix the rear clamping plate 105 to other supporting devices, such as tripods, monopods, dollies, the connector piece 102 or the portable device 100 directly to the rear plate 105. It also comprises fasteners, for example, a screw-lug nut arrangement 103 fixed by fastener element, such as pins, pintles, bolts, etc. in a manner that the tensioner is free to rotate. The multipurpose rear plate 105 also comprises friction bits 601 on its surface.

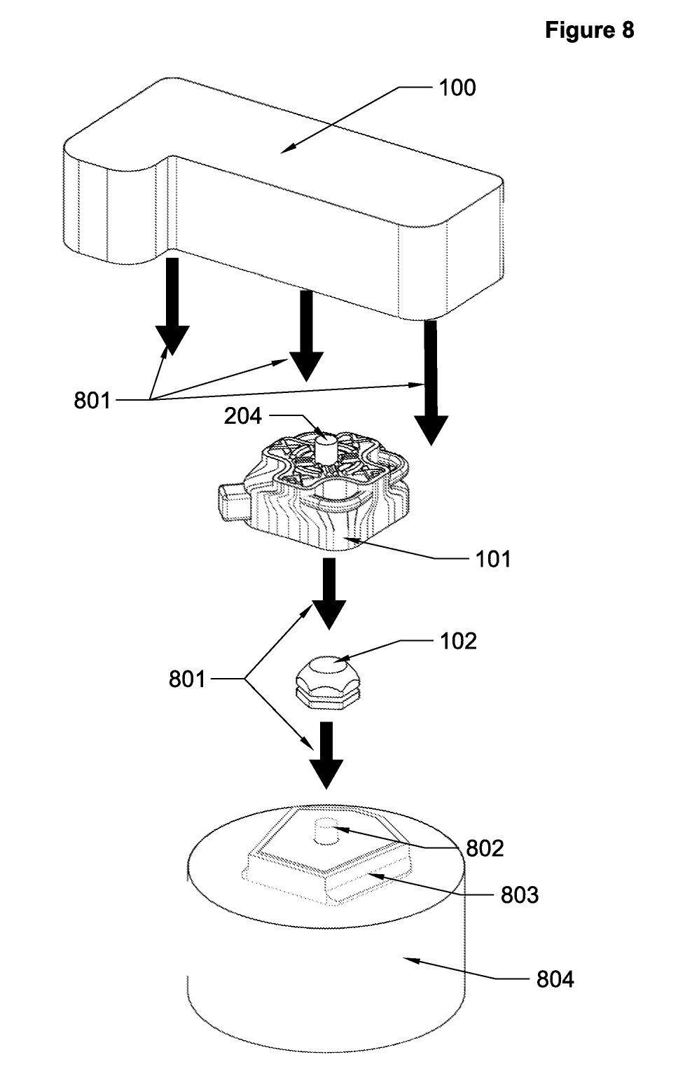

FIG. 8 shows the method of attaching the quick release device 101 to the connector piece 102. The portable equipment or electronic device 100 is attached to the quick release device 101 by means of the associated fastener 204 in the direction of the arrows 801. The connector piece 102 is attached to the suitable surface 804 or element 803 by means of the associated fastener 802 in the direction of the arrows 801. Finally the quick release device 101 is attached to the connector piece 102 in the direction of the arrow 801.

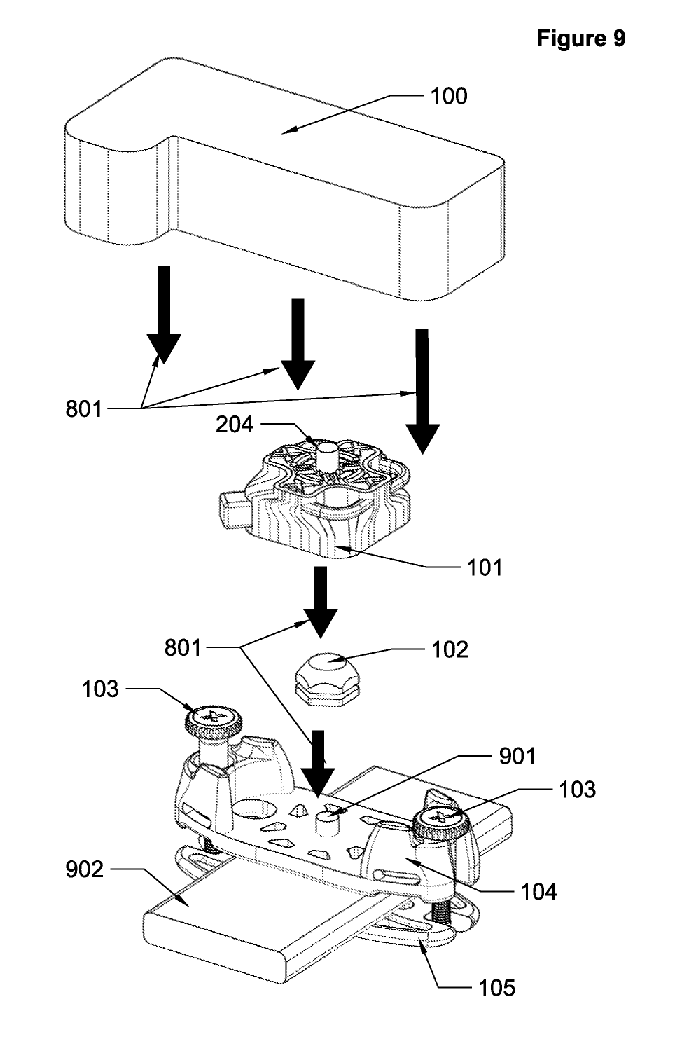

FIG. 9 shows the method of attaching the connector piece 102 to the clamping plates 104 and 105. The portable equipment or electronic device 100 is attached to the quick release device 101 by means of the associated fastener 204 in the direction of the arrows 801. The connector piece 102 is attached to the front clamping plate 104 by means of the associated fastener 901. The front damping plate 104 compress the element 902 against the rear clamping plate 105 by tightening the fasteners 103 associated with the clamping plates 104 and 105. Finally the quick release device 101 is attached to the connector piece 102 in the direction of the arrow 801.

Since many different embodiments of the present quick release mounting system can be performed without the spirit and scope of the invention, the invention resides in the claims hereinafter appended.

1. A multipurpose quick release mounting system comprising:
a quick release device having a housing hollow to receive the connector piece, a quick release mechanism and actuator configured to secure and release the connector piece, a redundant safety lock to secure and fix the connector piece firmly, a cushion and friction pad on the surface in contact to the portable devices, a fastener associated to the portable device to be attached, anchor loops on the body and a cover plate with a polygonal hollow that restricts the connector piece from free rotation once it is secured in place.

2. The multipurpose quick release mounting system of claim 1, further comprises a connector piece having a hollow to fix the said connector piece to different surfaces or elements by its associated fasteners, a groove that allows the insertion of the quick release actuator which secures or detaches the said connector piece with the action of the operator, a conical or pyramidal geometry in order to be easily inserted in the quick release device housing hollow, a polygonal base which allows to be positioned in different directions.

3. The multipurpose quick release mounting system of claim 1 also comprises front and rear multipurpose supporting or clamping plates having holes, slots, hollows, humps and cavities allowing its attachment to different surfaces and elements by means of different kind of fasteners, for example, screws, straps, webbings, cords, wire, ropes among others, a hollow to attach the connector piece to the said supporting plates by means of the associated connector piece fastener, a certain number of hollows to affix the rear supporting plate to the front plate by means of fasteners, a friction bits on the surface in contact with the attachment element.

4. A method of attaching the quick release device to the connector piece. The portable equipment or electronic device is attached to the quick release device by means of the associated fastener. The connector piece is attached to the suitable surface or element by means of the associated fastener. Finally the quick release device is attached to the connector piece in a frontal or top load gesture.

5. A method of attaching the connector piece to the clamping plates. The portable equipment or electronic device is attached to the quick release device by means of the associated fastener. The connector piece is attached to the front damping plate by means of the associated fastener. The front clamping plate compress the element against the rear clamping plate by tightening the fasteners associated with the clamping plates. Finally the quick release device is attached to the connector piece in a frontal or top load gesture.
